(19) United States
(12) Patent Application Publication
(10) Pub. No.: US 2009/0004584 A1
(43) Pub. Date: Jan. 1, 2009

(54) HYDROXYGALLIUM PHTHALOCYANINE PROCESSES AND PHOTOCONDUCTORS THEREOF

(75) Inventor: Jin Wu, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: XEROX CORPORATION, Stamford, CT (US)

(21) Appl. No.: 11/769,073

(22) Filed: Jun. 27, 2007

(51) Int. Cl. G03G 15/02; C09B 47/08

(52) U.S. Cl. 430/58.8; 430/59.4; 540/142

(57) ABSTRACT

A process which comprises treating a hydroxygallium phthalocyanine Type I with a weak acid having a pKa of at least equal to or greater than about −3, and subsequently contacting the hydroxygallium phthalocyanine Type I with an organic solvent.

### CROSS REFERENCE TO RELATED APPLICATIONS

In U.S. Application No. (not yet assigned—Attorney Docket No. 20070052-US-NP), filed concurrently herewith, on Titanyl Phthalocyanine Processes and Photoconductors Thereof, there is illustrated a process which comprises treating a Type I titanyl phthalocyanine with a weak acid having a pKa of at least equal to or greater than about −0.25; dissolving the weak acid treated Type I titanyl phthalocyanine in a solution comprising a trihaloacetic acid and an alkylene halide; adding said mixture comprising the dissolved Type I titanyl phthalocyanine to a solution comprising an alcohol and an alkylene halide thereby precipitating a Type Y titanyl phthalocyanine; and treating said Type Y titanyl phthalocyanine with monohalobenzene thereby resulting in a high sensitivity titanyl phthalocyanine.

### BACKGROUND

This disclosure is generally directed to processes for the preparation of hydroxygallium phthalocyanines, especially a high sensitivity hydroxygallium phthalocyanine Type V, a known phthalocyanine, and drum and belt layered photoreceptors, photoconductors, and the like. More specifically, the present disclosure is directed to hydroxygallium phthalocyanine processes where weak acids are selected, and to multilayered flexible or belt imaging members or devices comprised of an optional supporting medium like a substrate, a photogenerating layer containing the prepared hydroxygallium phthalocyanine Type V, and a charge transport layer, including a plurality of charge transport layers, such as a first charge transport layer and a second charge transport layer, an optional adhesive layer, an optional hole blocking or undercoat layer, an optional overcoating layer, and wherein at least one of the charge transport layers contains at least one charge transport component, a polymer or resin binder, and an optional antioxidant.

More specifically, there are disclosed processes for the preparation of hydroxygallium phthalocyanines formed, for example, by the hydrolysis of a halogallium phthalocyanine or an alkoxygallium phthalocyanine precursor to a hydroxygallium phthalocyanine Type I, mixing the resulting intermediate phthalocyanine with a weak acid, for example weaker than sulfuric acid, and conversion of the resulting hydroxygallium phthalocyanine to Type V hydroxygallium phthalocyanine by contacting the intermediate hydroxygallium phthalocyanine with an organic solvent; the hydrolysis of halogallium phthalocyanine or alkoxygallium phthalocyanine precursor to hydroxygallium phthalocyanine Type I, mixing or treating the Type I with a weak acid, and conversion of the resulting hydroxygallium phthalocyanine mixture to Type V hydroxygallium phthalocyanine by contacting the weak acid treated hydroxygallium phthalocyanine Type I mixture with an organic solvent of, for example, N,N-dimethylformamide, and wherein the precursor halogallium phthalocyanine Type I is obtained by the reaction of a gallium halide with a diiminoisoindolene in an organic solvent.

Also, there is illustrated herein in embodiments the incorporation into photoconductors of suitable high sensitivity photogenerating pigments, such as the hydroxygallium phthalocyanines prepared as illustrated herein. The selection of weak acids in the washing of the hydroxygallium phthalocyanine intermediate provides, for example, for the capture of impurities, such as gallium oxide and gallium chloride, and thereby generates a high sensitivity hydroxygallium phthalocyanine which permits lower CDS characteristics than when a weak acid is not used. High hydroxygallium phthalocyanine photogenerating dispersion stability and improved potlife are particularly desirable from the manufacturing point of view as the dispersion can be used over an extended period of time, like several months, without negative impacts on the coating process and the photosensitivity of the coated photoreceptors, an advantage achieved with the processes and photoconductors of the present disclosure. Poor dispersion stability can result in the hydroxygallium phthalocyanine pigment settling out quickly to prevent or inhibit a uniform coating of the photogenerating layer. When the photosensitivity of coated photoconductor does not substantially change with the aging of the hydroxygallium phthalocyanine dispersion, then the useful life of the dispersion (potlife) is prolonged allowing efficient utilization of the dispersion materials with minimum waste. Also, the excellent photosensitivity characteristics of the hydroxygallium phthalocyanine obtained with the weak acid, weaker than sulfuric acid having a pKa of −3, can be maintained for suitable periods of time.

Additionally, in embodiments the photoconductors disclosed herein permit minimal undesirable CDS developed image characteristics, excellent and in a number of instances low Vᵣ (residual potential), and allow the substantial prevention of Vᵣ cycle up when appropriate; high stable sensitivity; low acceptable image ghosting characteristics; and desirable toner cleanability.

Also included within the scope of the present disclosure are methods of imaging and printing with the photoconductor devices illustrated herein. These methods generally involve the formation of an electrostatic latent image on the imaging member, followed by developing the image with a toner composition comprised, for example, of thermoplastic resin, colorant, such as pigment, charge additive, and surface additives, reference U.S. Pat. Nos. 4,560,635; 4,298,697 and 4,338,390, the disclosures of which are totally incorporated herein by reference, subsequently transferring the image to a suitable substrate, and permanently affixing the image thereto. In those environments wherein the photoconductor is to be used in a printing mode, the imaging method involves the same operation with the exception that exposure can be accomplished with a laser device or image bar. More specifically, the imaging members and flexible belts disclosed herein can be selected for the Xerox Corporation iGEN3® machines that generate with some versions over 100 copies per minute. Processes of imaging, especially xerographic imaging, and printing, including digital, and/or color printing are thus encompassed by the present disclosure.

The photoconductors disclosed herein are in embodiments sensitive in the wavelength region of, for example, from about 400 to about 900 nanometers, and in particular from about 650 to about 850 nanometers, thus diode lasers can be selected as the light source. Moreover, the imaging members disclosed herein are in embodiments useful in high resolution color xerographic applications, particularly high-speed color copying, and printing processes.

### REFERENCES

There is illustrated in U.S. Pat. No. 5,521,306, the disclosure of which is totally incorporated herein by reference, a process for the preparation of Type V hydroxygallium phthalocyanine comprising the in situ formation of an alkoxy-bridged gallium phthalocyanine dimer, hydrolyzing the dimer to hydroxygallium phthalocyanine, and subsequently converting the hydroxygallium phthalocyanine product to Type V hydroxygallium phthalocyanine.

Illustrated in U.S. Pat. No. 5,482,811, the disclosure of which is totally incorporated herein by reference, is a process for the preparation of hydroxygallium phthalocyanine photogenerating pigments, which comprises hydrolyzing a gallium phthalocyanine precursor pigment by dissolving the hydroxygallium phthalocyanine in a strong acid, and then reprecipitating the resulting dissolved pigment in basic aqueous media; removing any ionic species formed by washing with water, concentrating the resulting aqueous slurry comprised of water and hydroxygallium phthalocyanine to a wet cake; removing water from said slurry by azeotropic distillation with an organic solvent, and subjecting said resulting pigment slurry to mixing with the addition of a second solvent to cause the formation of said hydroxygallium phthalocyanine polymorphs.

Also, in U.S. Pat. No. 5,473,064, the disclosure of which is totally incorporated herein by reference, there is illustrated a process for the preparation of photogenerating pigments of hydroxygallium phthalocyanine Type V essentially free of chlorine, whereby a pigment precursor Type I chlorogallium phthalocyanine is prepared by reaction of gallium chloride in a solvent, such as N-methylpyrrolidone, present in an amount of from about 10 parts to about 100 parts, and more specifically, about 19 parts with 1,3-diiminoisoindolene (DI³) in an amount of from about 1 part to about 10 parts, and more specifically, about 4 parts of DI³, for each part of gallium chloride that is reacted; hydrolyzing said pigment precursor chlorogallium phthalocyanine Type I by standard methods, for example acid pasting, whereby the pigment precursor is dissolved in concentrated sulfuric acid and then reprecipitated in a solvent, such as water, or a dilute ammonia solution, for example from about 10 to about 15 percent; and subsequently treating the resulting hydrolyzed pigment hydroxygallium phthalocyanine Type I with a solvent, such as N,N-dimethylformamide, present in an amount of from about 1 volume part to about 50 volume parts, and more specifically about 15 volume parts for each weight part of pigment hydroxygallium phthalocyanine that is used by, for example, ball milling the Type I hydroxygallium phthalocyanine pigment in the presence of spherical glass beads, approximately 1 millimeter to 5 millimeters in diameter, at room temperature, about 25° C., for a period of from about 12 hours to about 1 week, and more specifically, about 24 hours.

U.S. Pat. No. 6,376,141, the entire disclosure of which is incorporated herein by reference, illustrates various compositions comprising combinations of phthalocyanine pigments including hydroxygallium phthalocyanine pigments. Additionally, for example, U.S. Pat. No. 6,713,220, the disclosure of which is totally incorporated herein by reference, discloses a method of preparing a Type V hydroxygallium phthalocyanine.

A number of the appropriate components, amounts thereof, and process parameters of the above hydroxygallium phthalocyanine patents may be selected for the present disclosure in embodiments thereof.

There is illustrated in U.S. Pat. No. 6,913,863, the disclosure of which is totally incorporated herein by reference, a photoconductive imaging member comprised of a hole blocking layer, a photogenerating layer, and a charge transport layer, and wherein the hole blocking layer is comprised of a metal oxide; and a mixture of a phenolic compound and a phenolic resin wherein the phenolic compound contains at least two phenolic groups.

Layered photoconductors have been described in numerous U.S. patents, such as U.S. Pat. No. 4,265,990, the disclosure of which is totally incorporated herein by reference. Examples of photogenerating layer components disclosed in U.S. Pat. No. 4,265,990 include trigonal selenium, metal phthalocyanines, vanadyl phthalocyanines, and metal free phthalocyanines. Additionally, there is described in U.S. Pat. No. 3,121,006, the disclosure of which is totally incorporated herein by reference, a photoconductive member comprised of finely divided particles of a photoconductive inorganic compound dispersed in an electrically insulating organic resin binder.

The process for the preparation of photoconductors using dispersions are susceptible to many variables, such as, for example, material variables, including contents and purity of the material; the photogenerating dispersion components selected and amounts thereof; process variables, including milling time and milling procedure; and coating process variables, including web coating, dip coating, the drying process of several layers, the time interval between the coatings of successive layers, and the like. The net outcome of these variables is, for example, that the electrical characteristics of the prepared photoreceptors may be inconsistent during the manufacturing process.

Sensitivity is a valuable electrical characteristic of electrophotographic imaging members or photoreceptors. Sensitivity may be described in two aspects. The first aspect of sensitivity is spectral sensitivity, which refers to sensitivity as a function of wavelength. An increase in spectral sensitivity implies an appearance of sensitivity at a wavelength in which previously no sensitivity was detected. The second aspect of sensitivity, broadband sensitivity, is a change of sensitivity, for example an increase at a particular wavelength previously exhibiting sensitivity, or a general increase of sensitivity encompassing all wavelengths previously exhibiting sensitivity. This second aspect of sensitivity may also be considered as change of sensitivity, encompassing all wavelengths, with a broadband (white) light exposure. A problem encountered in the manufacturing of photoreceptors is maintaining consistent spectral and broadband sensitivity from batch to batch.

Typically, flexible photoreceptor belts are fabricated by depositing the various layers of photoactive coatings onto long webs that are thereafter cut into sheets. The opposite ends of each photoreceptor sheet are overlapped and ultrasonically welded together to form an imaging belt. In order to increase throughput during the web coating operation, the webs to be coated have a width of twice the width of a final belt. After coating, the web is slit lengthwise, and thereafter transversely cut into predetermined lengths to form photoreceptor sheets of precise dimensions that are eventually welded into belts. The web length in a coating run may be many thousands of feet long, and the coating run may take more than an hour for each layer.

### SUMMARY

Disclosed are photoconductors with many of the advantages illustrated herein, such as extended lifetimes of service of, for example, in excess of about 3,000,000 imaging cycles; rapid charge transfer to thereby improve print quality caused by temperature variation in proximity to the photoconductor; excellent electrical characteristics, for example high sensitivity; stable electrical properties; low image ghosting characteristics; resistance to charge transport layer cracking upon exposure to the vapor of certain solvents; excellent surface characteristics; improved wear resistance; compatibility with a number of toner compositions; consistent Vᵣ (residual potential) that is substantially flat or no change over a number of imaging cycles as illustrated by the generation of known PIDC (Photoinduced Discharge Curve); stable photogenerating dispersions, extended pot life and excellent optical absorption properties thereof, and the like, and where the photoconductors permit the generation of developed xerographic images with minimal charge deficient spots (CDS).

Further disclosed are drum or layered flexible photoresponsive imaging members.

Moreover, disclosed are layered belt and drum photoresponsive or photoconductive imaging members with mechanically robust and solvent resistant charge transport layers and with rapid transport of charge, especially holes.

Additionally disclosed are flexible imaging members with optional hole blocking layers comprised of metal oxides, phenolic resins, and optional phenolic compounds, and which phenolic compounds contain at least two, and more specifically, two to ten phenol groups or phenolic resins with, for example, a weight average molecular weight of, for example, from about 500 to about 3,000, permitting, for example, a hole blocking layer with excellent efficient electron transport which usually results in a desirable photoconductor low residual potential VIOW.

Also disclosed are photoconductors with rapid charge transporting characteristics, excellent and stable photosensitivity with minimum or no PIDC changes, as compared, for example, to photoconductors that are free of hydroxygallium phthalocyanine Type V.

### EMBODIMENTS

Aspects of the present disclosure include a process which comprises treating a hydroxygallium phthalocyanine Type I with a weak acid having a pKa of at least equal to or greater than about −3, and subsequently contacting the hydroxygallium phthalocyanine Type I with an organic solvent; a process wherein there is obtained hydroxygallium phthalocyanine Type V by first hydrolyzing a halogallium phthalocyanine or an alkoxy-bridged gallium phthalocyanine to the hydroxygallium phthalocyanine Type I; a process wherein the halogallium phthalocyanine is obtained by the reaction of a gallium halide with a 1,3-diiminoisoindolene or ortho-phthalodinitrile in an organic solvent, and wherein there is obtained hydroxygallium phthalocyanine Type V; a process wherein the hydroxygallium phthalocyanine Type V is obtained by the hydrolysis of halogallium phthalocyanine precursor to hydroxygallium phthalocyanine Type I, treatment of the resulting hydroxygallium phthalocyanine Type I with the weak acid, and conversion of the resulting weak acid treated hydroxygallium phthalocyanine Type I to Type V hydroxygallium phthalocyanine by contacting the hydroxygallium phthalocyanine Type I with an organic solvent of N,N-dimethylformamide, and wherein the precursor halogallium phthalocyanine is obtained by the reaction of a gallium halide with a 1,3-diiminoisoindolene or ortho-phthalodinitrile in an organic solvent; a process wherein the alkoxy-bridged gallium phthalocyanine is obtained by the reaction of a gallium halide, a 1,3-diiminoisoindolene, ortho-phthalodinitrile, or a diol in an organic solvent, and wherein the diol is selected from the group consisting of ethylene glycol, 1,3-propanediol, 2-methyl-1,3-propanediol, 2,2-dimethyl-1,3-propanediol, 1,3-butanediol, 2,3-butanediol, 1,4-butanediol, 1,4-cyclohexanediol, 1,6-hexanediol, and the like, and mixtures thereof, and there is obtained hydroxygallium phthalocyanine Type V; a process wherein the hydroxygallium phthalocyanine Type V is obtained by the hydrolysis of alkoxy-bridged gallium phthalocyanine precursor to hydroxygallium phthalocyanine Type I, treatment of the resulting hydroxygallium phthalocyanine Type I with the weak acid, and conversion of the resulting weak acid treated hydroxygallium phthalocyanine Type I to Type V hydroxygallium phthalocyanine by contacting the hydroxygallium phthalocyanine Type I with an organic solvent of N,N-dimethylformamide, and wherein the precursor halogallium phthalocyanine is obtained by the reaction of a gallium halide, a 1,3-diiminoisoindolene or ortho-phthalodinitrile, and ethylene glycol in an organic solvent; a process wherein the acid pKa is from about −1 to about 15, and wherein the weak acid captures the metallic impurities present in the hydroxygallium phthalocyanine Type I; a process wherein the pKa is from about 0 to about 10, and wherein the hydroxygallium phthalocyanine obtained is Type V hydroxygallium phthalocyanine; a process wherein the pKa is from about 1 to about 6, and wherein the hydroxygallium phthalocyanine obtained is Type V hydroxygallium phthalocyanine; a process wherein the weak acid is selected from the group consisting of acetic acid, trifluoroacetic acid, sulfurous acid, phosphoric acid, hydrofluoric acid, monofluoroacetic acid, monochloroacetic acid, monobromoacetic acid, monoiodoacetic acid, dichloroacetic acid, trichloroacetic acid, formic acid, oxalic acid, acetylsalicylic acid, nicotinic acid, pyruvic acid, propionic acid, oxalacetic acid, trifluoroacetic acid, and mixtures thereof; a process wherein the acid is an acidic aqueous solution containing from about 1 weight percent to about 50 weight percent of the acid; a process wherein the acid is comprised of an acidic aqueous solution containing from about 2 weight percent to about 20 weight percent of the acid; a process wherein the ratio of the hydroxygallium phthalocyanine Type I to the acid is from about 90/10 to about 30/70; a process wherein the ratio of the hydroxygallium phthalocyanine Type I to the acid is from about 80/20 to about 40/60; a process wherein the ratio of the hydroxygallium phthalocyanine Type I to the acid is from about 70/30 to about 50/50 wherein the hydroxygallium phthalocyanine obtained is Type V hydroxygallium phthalocyanine, and wherein there is removed from the hydroxygallium phthalocyanine Type I impurities prior to conversion to hydroxygallium phthalocyanine Type V; a process wherein the hydroxygallium phthalocyanine Type I is subjected to filtration, isolation, and drying, and wherein there is removed from the hydroxygallium phthalocyanine Type I metallic impurities prior to its conversion to hydroxygallium phthalocyanine Type V; a process wherein there results hydroxygallium phthalocyanine Type V with an X-ray diffraction pattern having characteristic diffraction peaks at Bragg angles of 7.4, 9.8, 12.4, 12.9, 16.2, 18.4, 21.9, 23.9, 25.0 and 28.1, with the highest peak at 7.4 degrees 20 (2Θ±0.2°); a process which comprises mixing a hydroxygallium phthalocyanine Type I with an acid with a pKa of from about -1 to about 12, and converting the resulting acid treated Type I to hydroxygallium phthalocyanine Type V, and which conversion is accomplished by treating or contacting hydroxygallium phthalocyanine Type I with an organic solvent selected from the group consisting of N,N-dimethylformamide, N-methyl pyrrolidinone, dimethylsulfoxide, pyridine, acetone, methyl ethyl ketone, methyl isobutyl ketone, and the like, and mixtures thereof; a process wherein there is removed from the hydroxygallium phthalocyanine Type I metallic impurities prior to its conversion to hydroxygallium phthalocyanine Type V; a photoconductor comprised of a supporting substrate, a photogenerating layer and a charge transport layer, and wherein the photogenerating layer contains hydroxygallium phthalocyanine Type V, which Type V is prepared by mixing hydroxygallium phthalocyanine Type I with a weak acid with a pKa of greater than about −3, and subsequently contacting the hydroxygallium phthalocyanine Type I mixture with an organic solvent to obtain the hydroxygallium phthalocyanine Type V; a photoconductor wherein the acid pKa is from about -1 to about 15, and wherein the organic solvent is selected from the group consisting of N,N-dimethylformamide, N-methyl pyrrolidinone, dimethylsulfoxide, pyridine, acetone, methyl ethyl ketone, methyl isobutyl ketone, and the like, and mixtures thereof; a photoconductor wherein the pKa is from about 1 to about 10; a photoconductor wherein the pKa is from about 2 to about 6; a photoconductor wherein the charge transport layer contains an aryl amine selected from the group consisting of at least one of N,N′-diphenyl-N,N-bis(3-methylphenyl)-1,1′-biphenyl-4,4′-diamine, N,N′-diphenyl-N,N-bis(4-methylphenyl)-1,1′-biphenyl-4,4′-diamine, N,N′-diphenyl-N,N-bis(2-methylphenyl)-1,1′-biphenyl-4,4′-diamine, and N,N,N′N′-tetra(4-methylphenyl)-(1,1′-biphenyl)-4,4′-diamine; a photoconductor further including a hole blocking layer, and an adhesive layer; a photoconductor wherein the charge transport layer comprises at least one of

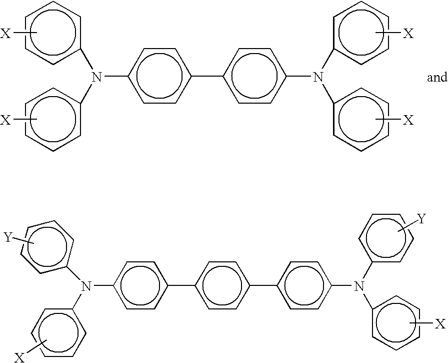

wherein each X is independently alkyl, alkoxy, aryl, a halogen, and mixtures thereof; and wherein X and Y are independently alkyl, alkoxy, aryl, a halogen, and mixtures thereof; a photoconductor wherein the hydroxygallium phthalocyanine Type V possesses diffraction peaks at Bragg angles of 7.4, 9.8, 12.4, 12.9, 16.2, 18.4, 21.9, 23.9, 25.0 and 28.1, with the highest peak at 7.4 degrees 2Θ (2Θ±0.2°); a photoconductor wherein the acid is selected from the group consisting of acetic acid, trifluoroacetic acid, sulfurous acid, phosphoric acid, hydrofluoric acid, monofluoroacetic acid, monochloroacetic acid, monobromoacetic acid, monoiodoacetic acid, dichloroacetic acid, trichloroacetic acid, formic acid, oxalic acid, acetylsalicylic acid, nicotinic acid, pyruvic acid, propionic acid, or oxalacetic acid; a photoconductor comprised of a supporting substrate, a photogenerating layer comprised of a photogenerating pigment of hydroxygallium phthalocyanine Type V, and wherein the Type V is prepared by treating a hydroxygallium phthalocyanine Type I with a weak acid having a pKa of at least equal to or greater than about −3, and subsequently contacting the hydroxygallium phthalocyanine Type I with an organic solvent; and wherein the hydroxygallium phthalocyanine Type V is obtained by the hydrolysis of halogallium phthalocyanine precursor to hydroxygallium phthalocyanine Type I, treatment of the resulting hydroxygallium phthalocyanine Type I with the weak acid, and conversion of the resulting weak acid treated hydroxygallium phthalocyanine Type I to Type V hydroxygallium phthalocyanine by contacting the hydroxygallium phthalocyanine Type I with an organic solvent of N,N-dimethylformamide, and wherein the precursor halogallium phthalocyanine is obtained by the reaction of a gallium halide with a 1,3-diiminoisoindolene or ortho-phthalodinitrile in an organic solvent.

In embodiments, the processes for the preparation of the hydroxygallium phthalocyanine Type V can be illustrated with reference to the following. The Type I hydroxygallium phthalocyanine can be generated by known methods, such as those illustrated in the relevant patents referenced herein, and more specifically, by the reaction of gallium chloride with 1,3-diiminoisoindolene in certain solvents like n-methylpyrrolidone, or the reaction of a mixture of phthalonitrile and gallium chloride with a chloronaphthalene solvent to form Type I; followed by the mixing of the Type I with a weak acid, and wherein Type V hydroxygallium phthalocyanine is converted from the resulting prepared and weak acid treated Type I hydroxygallium phthalocyanine in the presence in certain solvents like N,N-dimethylformamide; and in embodiments the preparation of hydroxygallium phthalocyanine polymorphs, which comprises the synthesis of a halo, especially chlorogallium phthalocyanine; hydrolysis thereof; and conversion of the hydroxygallium phthalocyanine Type I obtained after treatment with a weak acid to Type V hydroxygallium phthalocyanine. In embodiments, preparation of the precursor pigment halo, especially chlorogallium phthalocyanine Type I, can result in photogenerating pigments, specifically hydroxygallium phthalocyanine Type V with very low levels of chlorine of, in embodiments, less than 0.1 percent, and more specifically, from about 0.05 to about 0.75 percent. It is believed that impurities, such as chlorine, especially in excess of the aforementioned amounts, in the photogenerating Type V hydroxygallium phthalocyanine may cause a reduction in the xerographic performance thereof, and in particular, increased levels of dark decay and a negative adverse impact on the cycling performance of the photoreceptor device. The hydroxygallium and chlorogallium phthalocyanines can be identified by various known means including X-ray powder diffraction (XRPD).

In embodiments, the preparation of the precursor halo, especially chlorogallium phthalocyanine, can be accomplished by the reaction of a halo, especially chlorogallium, with diiminoisoindolene and an organic solvent like N-methylpyrrolidone; followed by washing with, for example, a solvent like dimethylformamide (DMF). The precursor obtained was identified as chlorogallium phthalocyanine Type I on the basis of its XRPD trace. Thereafter, the precursor is subjected to hydrolysis by heating in the presence of a strong acid like sulfuric acid (pKa =−3), and subsequently reprecipitating the dissolved pigment by mixing with a basic solution like ammonium hydroxide, and isolating the resulting pigment, which is identified as Type I hydroxygallium phthalocyanine on the basis of its XRPD trace. The obtained Type I is then mixed or contacted with a weak acid, more specifically a weak acid aqueous solution wherein the weak acid is weaker than sulfuric acid, and which weak acid possesses a pKa not less than about −3. The resulting weak acid treated Type I hydroxygallium phthalocyanine is isolated and then converted to Type V hydroxygallium phthalocyanine by adding thereto a solvent component like N,N-dimethylformamide, and subsequently stirring or alternatively milling in a closed container on an appropriate instrument, for example a ball mill, at room temperature, approximately 25° C., for a period of from about 8 hours to 1 week, and more specifically, about 24 hours. The pigment precursor Type I chlorogallium phthalocyanine can be prepared by the reaction of gallium chloride in a solvent, such as N-methylpyrrolidone, present in an amount of from about 10 parts to about 100 parts, and more specifically, about 19 parts, with 1,3-diiminoisoindolene (DI³) in an amount of from about 1 part to about 10 parts, and more specifically, about 4 parts of DI³ for each part of gallium chloride that is reacted, and wherein in embodiments the reaction is accomplished by heating at, for example, about 200° C. When the resulting pigment precursor chlorogallium phthalocyanine Type I is hydrolyzed by, for example, acid pasting whereby the pigment precursor is dissolved in concentrated sulfuric acid, and then reprecipitated in a solvent, such as water, or a dilute ammonia solution, for example from about 10 to about 15 percent, the hydrolyzed pigment contains very low levels of residual chlorine of from about 0.001 percent to about 0.1 percent, and in embodiments from about 0.03 percent of the weight of the Type I hydroxygallium phthalocyanine pigment, as determined by elemental analysis.

The Type I hydroxygallium phthalocyanine is then treated with a weak acid, and the hydroxygallium phthalocyanine Type V can be formed from the weak acid treated Type I hydroxygallium phthalocyanine. More specifically, the process comprises the reaction of 1 part of gallium chloride with from about 1 part to about 10 parts, and more specifically, about 4 parts of 1,3-diiminoisoindolene in a solvent, such as N-methyl pyrrolidone, in an amount of from about 10 parts to about 100 parts, and more specifically, about 19 parts for each part of gallium chloride that is used, provides a crude Type I chlorogallium phthalocyanine, which is subsequently washed with a component, such as dimethylformamide, to provide a pure form of Type I chlorogallium phthalocyanine as determined by X-ray powder diffraction; then dissolving 1 weight part of the resulting chlorogallium phthalocyanine in concentrated, about 94 percent, sulfuric acid in an amount of from about 1 weight part to about 100 weight parts, and in an embodiment about 5 weight parts, by stirring the pigment in the acid for an effective period of time, from about 30 seconds to about 24 hours, and in an embodiment about 2 hours at a temperature of from about 0° C. to about 75° C., and more specifically, about 40° C. in air or under an inert atmosphere, such as argon or nitrogen; adding the resulting mixture to a stirred organic solvent in a dropwise manner at a rate of about 0.5 milliliter per minute to about 10 milliliters per minute, and in an embodiment about 1 milliliter per minute to a nonsolvent, which can be a mixture comprised of from about 1 volume part to about 10 volume parts, and more specifically, about 4 volume parts of concentrated aqueous ammonia solution (14.8N) and from about 1 volume part to about 10 volume parts, and more specifically, about 7 volume parts of water for each volume part of sulfuric acid that was used, which solvent mixture was chilled to a temperature of from about −25° C. to about 10° C., and in an embodiment about −5° C. while being stirred at a rate sufficient to create a vortex extending to the bottom of the flask containing the solvent mixture; isolating the resulting blue pigment by, for example, filtration; and washing the hydroxygallium phthalocyanine product obtained with deionized water by redispersing and filtering from portions of deionized water, which portions are from about 10 volume parts to about 400 volume parts, and in an embodiment about 200 volume parts for each weight part of the precursor pigment chlorogallium phthalocyanine Type I. The product, a dark blue solid, was confirmed to be Type I hydroxygallium phthalocyanine on the basis of its X-ray powder diffraction pattern, having major peaks at 6.9, 13.1, 16.4, 21.0, 26.4, and the highest peak at 6.9 degrees 2θ.

The Type I hydroxygallium phthalocyanine product obtained can then be mixed with a weak acid. More specifically, the process comprises i) mixing 1 part of the Type I hydroxygallium phthalocyanine pigment with 10 parts of distilled water and 0.5 part of glacial acetic acid for half an hour; ii) filtration of the mixture to obtain the wet pigment; iii) reslurrying or redispersing the wet pigment with 20 parts of hot distilled water (>90° C.), filtration, then 20 parts of room temperature distilled water until the conductivity of the water is less than 10 μS; iv) reslurrying or redispersing the pigment with 20 parts of methanol, filtration, and drying under vacuum at 70° C. for at least 8 hours.

The weak acid treated Type I hydroxygallium phthalocyanine is then mixed with an organic solvent, such as N,N-dimethylformamide, by, for example, ball milling the weak acid treated Type I hydroxygallium phthalocyanine pigment in the presence of spherical glass beads, approximately 1 millimeter to 5 millimeters in diameter, at room temperature, about 25° C., for a period of from about 12 hours to about 1 week, and more specifically about 24 hours, to obtain hydroxygallium phthalocyanine Type V in a purity of up to about 99.5 percent, and with minimal chlorine content.

For the preparation of the precursor Type I chlorogallium phthalocyanine, the process in embodiments comprises the reaction by heating of 1 part gallium chloride with from about 1 part to about 10 parts, and more specifically, about 4 parts of DI³ (1,3-diiminoisoindolene) in the presence of N-methyl pyrrolidone solvent in an amount of from about 10 parts to about 100 parts, and more specifically, about 19 parts, whereby there is obtained a crude chlorogallium phthalocyanine Type I, which is subsequently purified, up to about a 99.5 percent purity, by washing with, for example, hot dimethylformamide, at a temperature of from about 70° C. to about 150° C., and more specifically, about 150° C. in an amount of from about 1 to about 10, and more specifically, about 3 times the volume of the solid being washed.

In embodiments, the process comprises 1) the addition of 1 part of gallium chloride to a stirred solvent N-methyl pyrrolidone present in an amount of from about 10 parts to about 100 parts, and more specifically, about 19 parts with from about 1 part to about 10 parts, and more specifically, about 4 parts of 1,3-diiminoisoindolene; 2) relatively slow application of heat using an appropriate sized heating mantle at a rate of about 1 degree per minute to about 10 degrees per minute, and more specifically, about 5 degrees per minute until refluxing occurs at a temperature of about 200° C.; 3) continued stirring at the reflux temperature for a period of about 0.5 hour to about 8 hours, and more specifically, about 4 hours; 4) cooling of the reactants to a temperature of about 130° C. to about 180° C., and more specifically, about 160° C. by removal of the heat source; 5) filtration of the flask contents through, for example, an M-porosity sintered glass funnel, which was preheated using a solvent which is capable of raising the temperature of the funnel to about 150° C., for example, boiling N,N-dimethylformamide in an amount sufficient to completely cover the resulting purple solid by slurrying the solid in portions of boiling DMF either in the funnel or in a separate vessel in a ratio of about 1 to about 10, and more specifically, about 3 times the volume of the solid being washed until the hot filtrate became light blue in color; 7) cooling and further washing the solid of impurities by slurrying the solid in several portions of N,N-dimethylformamide at room temperature, about 25° C., approximately equivalent to about three times the volume of the solid being washed, until the filtrate became light blue in color; 8) washing the solid of impurities by slurrying in portions of an organic solvent, such as methanol, acetone, water, and the like, and in an embodiment methanol at room temperature, about 25° C., approximately equivalent to about three times the volume of the solid being washed, until the filtrate became light blue in color; 9) oven drying the solid in the presence of a vacuum or in air at a temperature of from about 25° C. to about 200° C., and more specifically, about 70° C. for a period of from about 2 hours to about 48 hours, and more specifically, about 24 hours thereby resulting in the isolation of a shiny purple solid which was identified as being Type I chlorogallium phthalocyanine by its X-ray powder diffraction trace, having major peaks at 9.1, 11.0, 18.8, 20.3, and the highest peak at 27 degrees 2Θ. The Type I chlorogallium phthalocyanine is then converted to hydroxygallium phthalocyanine Type I, followed by mixing the hydroxygallium phthalocyanine Type I with a weak acid having a pKa greater than about −3, and converting the weak acid treated hydroxygallium phthalocyanine Type I with N,N-dimethylformamide thereby resulting in Type V hydroxygallium phthalocyanine as illustrated herein.

Also, in embodiments there can be selected for the processes illustrated herein wherein, for example, hydroxygallium Type V essentially free of chlorine can be obtained by selecting a mixture of DI³ and phthalonitrile in place of DI³ alone. More specifically, the pigment precursor chlorogallium phthalocyanine Type I can be prepared by reaction of 1 part gallium chloride with a mixture comprised of from about 0.1 part to about 10 parts, and more specifically, about 1 part of DI³ (1,3-diiminoisoindolene), and from about 0.1 part to about 10 parts, and more specifically, about 3 parts of o-phthalonitrile in the presence of N-methyl pyrrolidone solvent, in an amount from about 10 parts to about 100 parts, and more specifically, about 19 parts. The resulting pigment was identified as being Type I chlorogallium phthalocyanine by its X-ray powder diffraction trace having major peaks at 9.1, 11.0, 18.8, 20.3, and the highest peak at 27 degrees 2Θ. When this pigment precursor is hydrolyzed by, for example, acid pasting, whereby the pigment precursor is dissolved in concentrated sulfuric acid and then reprecipitated in a solvent, such as water, or a dilute ammonia solution, for example from about 10 to about 15 percent, the hydrolyzed Type V pigment contains very low levels of residual chlorine. It is believed that impurities, such as chlorine, in the photogenerating material can cause a reduction in the xerographic performance, and in particular, increased levels of dark decay and a negative impact on the cycling performance of layered photoconductive imaging members thereof.

In embodiments, the processes for the preparation of hydroxygallium phthalocyanine Type V comprise the reaction of 1 part of gallium chloride with a mixture comprised of from about 0.1 part to about 10 parts, and more specifically, about 1 part of 1,3-diimiinoisoindolene, and from about 0.1 part to about 10 parts, and more specifically, about 3 parts of o-phthalonitrile in a solvent, such as N-methyl pyrrolidone, present in an amount of from about 10 parts to about 100 parts, and more specifically, about 19 parts for each part of gallium chloride that is used, to provide crude Type I chlorogallium phthalocyanine, which is subsequently washed with a component, such as hot N,N-dimethylformamide (DMF), by slurrying this crude solid in portions of DMF at a temperature of from about 75° C. to about 150° C., and more specifically, about 150° C. either in a funnel or in a separate vessel in a ratio of about 1 to about 10, and more specifically, about 3 times the volume of the solid being washed, until the hot filtrate became light blue in color, to provide a pure form of chlorogallium phthalocyanine Type I as determined by X-ray powder diffraction; dissolving the resulting chlorogallium phthalocyanine Type I in concentrated sulfuric acid in an amount of from about 1 weight part to about 100 weight parts, and in an embodiment about 5 weight parts of concentrated, about 94 percent, sulfuric acid by stirring the Type I pigment in the acid for an effective period of time, from about 30 seconds to about 24 hours, and in an embodiment about 2 hours at a temperature of from about 0° C. to about 75° C., and more specifically, about 40° C. in air or under an inert atmosphere, such as argon or nitrogen; adding the dissolved precursor pigment chlorogallium phthalocyanine Type I in a dropwise manner at a rate of about 0.5 milliliter per minute to about 10 milliliters per minute, and in an embodiment about 1 milliliter per minute to a solvent mixture which enables reprecipitation of the dissolved pigment, which solvent can be a mixture comprised of from about 1 volume part to about 10 volume parts, and more specifically, about 4 volume parts of concentrated aqueous ammonia solution (14.8 N), and from about 1 volume part to about 10 volume parts, and more specifically, about 7 volume parts of water for each volume part of sulfuric acid that was used, which solvent mixture was chilled to a temperature of from about −25° C. to about 10° C., and in an embodiment about −5° C. while being stirred at a rate sufficient to create a vortex extending to the bottom of the flask containing the solvent mixture; filtering the dark blue suspension through a glass fiber filter fitted in a porcelain funnel; washing the isolated solid by redispersing in water by stirring for a period of from about 1 minute to about 24 hours, and in an embodiment about 1 hour in an amount of from about 10 volume parts to about 400 volume parts, and in an embodiment about 200 volume parts relative to the original weight of solid Type I pigment used, followed by filtration as illustrated herein, until the conductivity of the filtrate was measured as less than 20 μS; and drying the resulting blue pigment in air or in the presence of a vacuum at a temperature of from about 25° C. to about 200° C., and in an embodiment in air at about 70° C. for a period of from about 5 minutes to about 48 hours, and in an embodiment about 12 hours to afford a dark blue powder in a desirable yield of from about 75 percent to about 99 percent, and in an embodiment about 97 percent which has been identified as being Type I hydroxygallium phthalocyanine on the basis of its XRPD spectrum, having major peaks at 6.9, 13.1, 16.4, 21.0, 26.4, and the highest peak at 6.9 degrees 2Θ. The Type I hydroxygallium phthalocyanine product so obtained can then be treated with weak acid and then a solvent, such as N,N-dimethylformamide, present in an amount of from about 1 volume part to about 50 volume parts, and more specifically, about 15 volume parts for each weight part of pigment hydroxygallium phthalocyanine that is used by, for example, ball milling the weak acid treated Type I hydroxygallium phthalocyanine pigment in the presence of spherical glass beads, approximately 1 millimeter to 5 millimeters in diameter, at room temperature, about 25° C., for a period of from about 12 hours to about 1 week, and more specifically, about 24 hours, such that there is obtained a hydroxygallium phthalocyanine Type V, in a purity of from about 95 to about 99.5 percent, and with minimal chlorine.

In another embodiment, the process comprises 1) the addition of 1 part of gallium chloride to the stirred solvent N-methyl pyrrolidone present in an amount of from about 10 parts to about 100 parts, and more specifically, about 19 parts with from about 0.1 part to about 4 parts, and more specifically, about 1 part of 1,3-diiminoisoindolene, and from about 0.1 part to about 4 parts, and more specifically, about 3 parts of o-phthalonitrile, such that the combination of the latter two reagents totals about 4 parts for each part of gallium chloride that is used; 2) relatively slow, but steady application of heat using an appropriately sized heating mantle at a rate of about 1 degree per minute to about 10 degrees per minute, and more specifically, about 5 degrees per minute until refluxing occurs at a temperature of about 200° C.; 3) continued stirring at the reflux temperature for a period of about 1/2 hour to about 8 hours, and more specifically, about 4 hours; 4) cooling of the reactants to a temperature of about 130° C. to about 180° C., and more specifically, about 160° C. by removal of the heat source; 5) filtration of the flask contents through, for example, an M-porosity (10 to 15 μm) sintered glass funnel, which was preheated using a solvent which is capable of raising the temperature of the funnel to about 150° C., for example boiling N,N-dimethylformamide in an amount sufficient to completely cover the bottom of the filter funnel so as to prevent blockage of the funnel; 6) washing the resulting purple solid by slurrying the solid in portions of boiling DMF either in the funnel or in a separate vessel in a ratio of about 1 to about 10, and more specifically, about 3 times the volume of the solid being washed until the hot filtrate became light blue in color; 7) cooling and further washing the solid of impurities by slurrying the solid in several portions of N,N-dimethylformamide at room temperature, about 25° C., approximately equivalent to about three times the volume of the solid being washed until the filtrate became light blue in color; 8) washing the solid of impurities by slurrying in several portions of an organic solvent, such as methanol, acetone, water, mixtures thereof, and the like, and in an embodiment methanol at room temperature, about 25° C., approximately equivalent to about three times the volume of the solid being washed until the filtrate became light blue in color; and 9) oven drying the solid in the presence of a vacuum or in air at a temperature of from about 25° C. to about 200° C., and more specifically, about 70° C. for a period of from about 2 hours to about 48 hours, and more specifically, about 24 hours thereby resulting in the isolation of a shiny purple solid which was identified as being Type I chlorogallium phthalocyanine by its X-ray powder diffraction trace with major peaks at 9.1, 11.0, 18.8, 20.3, and the highest peak at 27 degrees 2Θ. This particular embodiment can result in a cost savings of $1,000 per kilogram of chlorogallium phthalocyanine Type I that is realized.

The Type I chlorogallium phthalocyanine obtained can then be converted to Type I hydroxygallium phthalocyanine by the dissolution thereof, in concentrated sulfuric acid, and thereafter reprecipitating the product obtained in a solvent mixture of, for example, aqueous ammonia solution. In a specific embodiment of the present disclosure, the Type I chlorogallium phthalocyanine obtained can be converted to Type I hydroxygallium phthalocyanine by 1) dissolving 1 weight part of the Type I chlorogallium phthalocyanine pigment in a ratio of from about 1 weight part to about 100 weight parts, and in an embodiment about 5 weight parts of concentrated, about 94 percent, sulfuric acid by stirring the pigment in the acid for an effective period of time, from about 30 seconds to about 24 hours, and in an embodiment about 2 hours at a temperature of from about 0° C. to about 75° C., and more specifically, about 40° C. in air or under an inert atmosphere such as argon or nitrogen; 2) reprecipitating the dissolved Type I chlorogallium phthalocyanine pigment by adding the dissolved solution in a dropwise manner at a rate of about 0.5 milliliter per minute to about 10 milliliters per minute, and in an embodiment about 1 milliliter per minute to a nonsolvent, which can be a mixture comprised of from about 1 volume part to about 10 volume parts, and more specifically, about 4 volume parts of a concentrated aqueous ammonia solution (14.8 N), and from about 1 volume part to about 10 volume parts, and more specifically, about 7 volume parts of water, for each volume part of sulfuric acid that was used, which solvent mixture was chilled to a temperature of from about −25° C. to about 10° C., and in an embodiment about −5° C. while being stirred at a rate sufficient to create a vortex extending to the bottom of the flask containing the solvent mixture; 3) filtering the dark blue suspension through a glass fiber filter fitted in a porcelain funnel; 4) washing the isolated solid by redispersing in water by stirring for a period of from about 1 minute to about 24 hours, and in an embodiment about 1 hour in an amount of from about 10 volume parts to about 400 volume parts, and in an embodiment about 200 volume parts relative to the original weight of the solid Type I pigment used, followed by filtration as illustrated herein; 5) repeating 3 and 4 until the conductivity of the filtrate was measured as less than about 20 μS, and more specifically, about 18 μS; and 6) drying the resulting blue pigment in air or in the presence of a vacuum at a temperature of from about 25° C. to about 200° C., and in an embodiment in air at about 70° C. for a period of from about 5 minutes to about 48 hours, and in an embodiment about 12 hours to afford a dark blue powder in a desirable yield of from about 75 percent to about 99 percent, and in an embodiment about 97 percent, which has been identified as being Type I hydroxygallium phthalocyanine on the basis of its XRPD spectrum, having major peaks at 6.9, 13.1, 16.4, 21.0, 26.4, and the highest peak at 6.9 degrees 2Θ. The aforementioned Type I hydroxygallium phthalocyanine, which particles were found in embodiments to be very small, from about 0.01 μm to about 0.1 μm, and in an embodiment about 0.03 μm in diameter, can be selected as a photogenerator for use in a layered photoconductive device or imaging member, or can be utilized as an intermediate for the conversion thereof to Type V hydroxygallium phthalocyanine by the treatment thereof with a solvent, such as N,N-dimethylformamide, by, for example, ball milling the Type I hydroxygallium phthalocyanine pigment and a weak acid in the presence of spherical glass beads, approximately 1 millimeter to 5 millimeters in diameter, at room temperature, about 25° C., for a period of from about 12 hours to about 1 week, and more specifically, about 24 hours.

More specifically, the Type I hydroxygallium phthalocyanine obtained can be treated by a weak acid aqueous solution and then isolated, followed by ball milling a mixture of the weak acid treated Type I hydroxygallium phthalocyanine pigment and a suitable solvent, for example N,N-dimethylformamide, present in an amount of from about 5 volume parts to about 50 volume parts, and more specifically, about 15 volume parts for each weight part of pigment, hydroxygallium phthalocyanine Type I, that is used in the presence of spherical glass beads, approximately 1 millimeter to 5 millimeters in diameter, at room temperature, about 25° C., for a period of from about 12 hours to about 1 week, and more specifically, about 24 hours to provide Type V hydroxygallium phthalocyanine having exceptionally low levels of chlorine, of from about 0.001 percent to about 0.1 percent, and in an embodiment about 0.01 percent of the weight of the Type V hydroxygallium pigment, as determined by elemental analysis, and very small particle size of from about 0.01 μm to about 0.1 μm, and in an embodiment about 0.03 μm in diameter, when the precursor pigment chlorogallium phthalocyanine Type I was prepared using 1 part of gallium chloride, and from about 1 part to about 10 parts, and more specifically, about 4 parts of DI³ in about 19 parts of N-methylpyrrolidone as reagents, and in an embodiment 0.01 percent chlorine, as measured by elemental analysis, and very small particle size, from about 0.01 μm to about 0.1 μm, and in an embodiment about 0.03 μm, when the precursor pigment chlorogallium phthalocyanine Type I was prepared using 1 part of gallium chloride with a mixture comprised of from about 0.1 part to about 10 parts, and more specifically, about 1 part of DI³, and from about 0.1 part to about 10 parts, and more specifically, about 3 parts of o-phthalonitrile, such that the latter two reagents total 4 parts, for each part of gallium chloride used, and about 19 parts of N-methylpyrrolidone as reagents.

Other synthetic preparation methods include, for example, the reaction of 1 part of gallium chloride with from about 1 part to about 10 parts, and more specifically, about 4 parts of o-phthalonitrile in about 19 parts of N-methylpyrrolidone or chloronaphthalene can be selected to prepare the precursor chlorogallium phthalocyanine Type I, however, higher levels of chlorine may be retained in the final product Type V hydroxygallium phthalocyanine, for example from about 0.3 percent to about 0.8 percent, and in an embodiment 0.5 percent of chlorine, as measured by elemental analysis. It is believed that impurities, such as chlorine, at certain amounts like 0.5 percent in the photogenerating material or pigment may cause a reduction in the xerographic performance of the pigment, and in particular, increased levels of dark decay and a negative impact on the cycling performance of the resulting layered photoconductive imaging members. The Type I hydroxygallium phthalocyanine obtained can be treated by a weak acid, followed by mixing the weak acid treated Type I hydroxygallium phthalocyanine with a suitable solvent, present in an amount of from about 5 volume parts to about 50 volume parts, and more specifically, about 15 volume parts for each weight part of pigment, hydroxygallium phthalocyanine Type I, that is used in the presence of spherical glass beads, approximately 1 millimeter to 5 millimeters in diameter, at room temperature, about 25° C., for a period of from about 12 hours to about 1 week, and more specifically, about 24 hours, to provide Type V hydroxygallium phthalocyanine having excellent xerographic characteristics when selected as a photogenerator in a layered photoconductive imaging member with a supporting substrate and a charge transport layer.

In embodiments of the present disclosure, there are provided processes for the preparation of Type V hydroxygallium phthalocyanine, which comprise the dissolution of 1 part gallium chloride in about 1 part to about 100 parts, and more specifically, about 10 parts of an organic solvent, such as benzene, toluene, xylene or the like, at a temperature of from about 0° C. to 10° C., and more specifically, at a temperature of about 25° C. to form a solution of gallium chloride; followed by the addition of 3 parts of an alkali metal alkoxide, such as sodium methoxide, sodium ethoxide, sodium propoxide, or the like, more specifically in a solution form, to produce a gallium alkoxide solution, and an alkali metal salt byproduct, for example sodium chloride, at a temperature of from about 0° C. to about 100° C., and more specifically, at a temperature of about 20° C. to about 40° C., followed by the reaction with from about 1 part to about 10 parts, and more specifically, about 4 parts ortho-phthalodinitrile or 1,3-diiminoisoindolene, and a diol, such as 1,2-ethanediol (ethylene glycol), 1,2-propanediol (propylene glycol) or 1,3-propanediol, in an amount of from about 3 parts to about 100 parts, and more specifically, about 10 parts for each part of gallium alkoxide formed at a temperature of from about 150° C. to about 220° C., and more specifically, at a temperature of 195° C. for a period of 30 minutes to 6 hours, and more specifically, about 2 hours to provide an alkoxy-bridged gallium phthalocyanine dimer pigment precursor; which product photogenerating pigment is isolated by filtration at a temperature of about 20° C. to about 180° C., and more specifically, at about 120° C. to provide a dark blue solid. The isolated pigment is subsequently washed with an organic solvent such as N,N-dimethylformamide at a temperature of from about 20° C. to about 120° C., and more specifically, at a temperature of about 80° C., followed by washing with aqueous solvents, such as aqueous ammonium hydroxide, aqueous sodium hydroxide, or the like, cold or hot water, and possibly another organic solvent wash to provide a pure form of the alkoxy-bridged gallium phthalocyanine dimer. Each different diol used for the phthalocyanine synthesis will produce a particular alkoxy-bridged gallium phthalocyanine dimer product, as determined by, for example, infrared (IR) spectroscopy, nuclear magnetic resonance (NMR), and X-ray powder diffraction pattern (XRD). The alkoxy-bridged gallium phthalocyanine dimer pigment (1 weight part) is dissolved in concentrated sulfuric acid (about 95 percent) in an amount of from about 1 weight part to about 100 weight parts, and in an embodiment about 25 weight parts, by stirring the pigment in the acid for an effective period of time, from about one minute to about 24 hours, and in an embodiment about 2 hours, at a temperature of from about 0° C. to about 75° C., and more specifically, about 40° C. in air or under an inert atmosphere, such as argon or nitrogen; adding the resulting mixture at a controlled rate to a stirred solvent, such as water or a basic aqueous solution, which can be an aqueous ammonia solution of from about 3 molar to about 15 molar concentration, and more specifically, about 6 molar to 10 molar concentration, selecting from about 1 volume part to about 10 volume parts of the basic solution for each volume part of sulfuric acid that was used such that at the end of the precipitation step the pH of the pigment suspension should be over 7, which solvent is chilled while being stirred, in order to maintain a temperature from about −5° C. to about 40° C. during the pigment precipitation; isolating the resulting blue pigment by, for example, filtration, and washing the hydroxygallium phthalocyanine product obtained with deionized water by, for example, repeatedly redispersing and filtering the pigment until the filtrate is of neutral pH. The product is a dark blue solid with an X-ray diffraction pattern having major peaks at Bragg angles of 6.8, 13.0, 16.5, 21.0, 26.3 and 29.5, with the highest peak at 6.8 degrees 2Θ (2Θ±0.2°), described as Type I hydroxygallium phthalocyanine. The Type I hydroxygallium phthalocyanine product obtained can be contacted or treated with a weak acid that has a pKa not less than −3, and isolated. More specifically, the process comprises i) mixing 1 part of the Type I hydroxygallium phthalocyanine pigment with 10 parts of distilled water and 0.5 part of glacial acetic acid for half an hour; ii) filtration of the mixture to obtain the wet pigment; iii) reslurrying or redispersing the wet pigment with 20 parts of hot distilled water (>90° C.), filtration, then 20 parts of room temperature distilled water until the conductivity of the water is less than 10 μS; iv) reslurrying or redispersing the pigment with 20 parts of methanol, filtration, and drying under vacuum at 70° C. for at least 8 hours. The weak acid treated Type I hydroxygallium phthalocyanine is then mixed with a polar aprotic solvent, such as N,N-dimethylformamide, N-methylpyrrolidone, or the like, by, for example, stirring, ball milling, or otherwise contacting the Type I hydroxygallium phthalocyanine pigment with the aforementioned solvent in the absence or presence of grinding media, such as stainless steel shot, spherical or cylindrical ceramic media, or spherical glass beads, at a temperature of from about 0° C. to about 40° C., for a period of from about 2 hours to about 1 week, and more specifically, about 12 to 24 hours, such that there is obtained a Type V hydroxygallium phthalocyanine polymorph with an X-ray diffraction pattern having major peaks at Bragg angles of 7.4, 9.8, 12.4, 12.9, 16.2, 18.4, 21.9, 23.9, 25.0 and 28.1, with the highest peak at 7.4 degrees 2Θ (2Θ±0.2°); and in situ processes for the preparation of Type V hydroxygallium phthalocyanine, which comprise the dissolution of 1 part gallium chloride in about 1 part to about 100 parts, and more specifically, 10 parts of toluene at a temperature of from about 0C to about 100° C., and preferably at a temperature of about 25° C., to form a solution of gallium chloride; followed by the addition of 3 parts of a sodium methoxide solution in methanol to form a gallium methoxide solution and sodium chloride byproduct, for example, at a temperature of from about 0° C. to about 100° C., and more specifically, at a temperature of about 20° C. to about 40° C., followed by reaction with from about 1 part to about 10 parts, and more specifically, about 4 parts of ortho-phthalodinitrile, and 1,2-ethanediol (ethylene glycol) in an amount of from about 3 parts to about 100 parts, and more specifically, about 10 parts for each part of gallium alkoxide formed at a temperature of from about 150° C. to about 220° C., and more specifically, at a reflux temperature of about 190° C. to about 195° C. for a period of 20 minutes to 6 hours, and more specifically, about 2 hours to provide an alkoxy-bridged gallium phthalocyanine dimer pigment precursor; which dimer pigment is isolated by filtration at a temperature of about 20° C. to about 180° C., and more specifically, at about 120° C. to give a dark blue solid. The isolated pigment is subsequently washed with an organic solvent, such as dimethylformamide, at a temperature of from about 20° C. to about 120° C., and more specifically, at a temperature of about 80° C., followed by washing with hot water, and another organic solvent wash to provide a pure form of the precursor alkoxy-bridged gallium phthalocyanine dimer in a yield of about 75 percent, calculated based upon the amount of gallium chloride used. The specific alkoxy-bridged gallium phthalocyanine dimer product resulting from the synthesis using ethylene glycol is 1,2-di(oxogallium phthalocyaninyl) ethane, C₃₂H₁₆N₈GaOCH₂CH₂OGaN₈H₁₆C₃₂, having an XRD pattern with major peaks at Bragg angles of 6.7, 8.9, 12.8, 13.9, 15.7, 6.6, 21.2, 25.3, 25.9 and 28.3, with the highest peak at 6.7 degrees 2Θ (2Θ±0.2°). The 1,2-di(oxogallium phthalocyaninyl) ethane pigment precursor (1 weight part) is dissolved in concentrated sulfuric acid (95 to 98 percent) in an amount of from about 1 weight part to about 100 weight parts, and preferably about 25 to 30 weight parts by stirring the pigment in the acid for an effective period of time, from about 30 minutes to about 6 hours, and in an embodiment about 2 hours at a temperature of from about 0C to about 75° C., and more specifically, about 30° C. to 50° C. in air or under an inert atmosphere, such as argon or nitrogen; adding the resulting mixture at a controlled rate to a stirred solvent, such as water, or a basic aqueous solution, such as aqueous ammonia solution of about 6 molar to 10 molar concentration, more specifically with the aqueous ammonia solution in such an amount that at the end of the precipitation step the pH of the pigment suspension should be about 8 with the solvent being chilled and stirred in order to maintain a temperature of from about −5° C. to about 40° C. during the pigment precipitation, and more specifically, under 25° C.; isolating the resulting blue pigment by, for example, filtration; and washing the hydroxygallium phthalocyanine product obtained with deionized water by, for example, redispersing and filtering using portions of deionized water, which portions are from about 10 volume parts to about 400 volume parts for each weight part of alkoxy-bridged gallium phthalocyanine dimer pigment precursor which was used. The product is a dark blue solid with an X-ray diffraction pattern having major peaks at Bragg angles of 6.8, 13.0, 16.5, 21.0, 26.3 and 29.5, with the highest peak at 6.8 degrees 2Θ (2Θ±0.2°), described as Type I hydroxygallium phthalocyanine. The Type I hydroxygallium phthalocyanine product obtained can be contacted or treated with a weak acid that has a pKa not less than 0 and isolated. More specifically, the process comprises i) mixing 1 part of the Type I hydroxygallium phthalocyanine pigment with 10 parts of distilled water and 0.5 part of glacial acetic acid for half an hour; ii) filtration of the mixture to obtain the wet pigment; iii) reslurrying or redispersing the wet pigment with 20 parts of hot distilled water (>90° C.), filtration, then 20 parts of room temperature distilled water until the conductivity of the water is less than 10 μS; iv) reslurrying or redispersing the pigment with 20 parts of methanol, filtration, and drying under vacuum at 70° C. for at least 8 hours. The weak acid treated Type I hydroxygallium phthalocyanine product obtained can then be treated with a polar aprotic solvent, such as N,N-dimethylformamide, N-methylpyrrolidone, or the like, by, for example, ball milling the Type I hydroxygallium phthalocyanine pigment in the presence of spherical glass beads, approximately 1 millimeters to 6 millimeters in diameter, at about 25° C., for a period of from about 1 hour to about 1 week, and more specifically, about 1 to 24 hours, such that there is obtained a Type V hydroxygallium phthalocyanine with an X-ray diffraction pattern having major peaks at Bragg angles of 7.4, 9.8, 12.4, 12.9, 16.2, 18.4, 21.9, 23.9, 25.0 and 28.1, with the highest peak at 7.4 degrees 2Θ (2Θ±0.2°).

In embodiments, the diol selected for the process of the present invention is as indicated herein, and includes ethylene glycol. 1,3-propanediol, 2-methyl-1,3-propanediol, 2,2-dimethyl-1,3-propanediol, 1,3-butanediol, 2,3-butanediol, 1,4-butanediol, 1,4-cyclohexanediol, or 1,6-hexanediol.

In embodiments, the present disclosure relates to a process for the preparation of Type V hydroxygallium phthalocyanine which comprises the formation of an alkoxy-bridged gallium phthalocyanine dimer by the reaction of an organic gallium complex of, for example, a metal alkoxide like gallium alkoxide, and corresponding halide precipitate, metal acetates like gallium acetate instead of the alkoxide, and the like with ortho-phthalodinitrile or 1,3-diiminoisoindoline and a diol; hydrolyzing the resulting alkoxy-bridged gallium phthalocyanine dimer to hydroxygallium phthalocyanine Type I; treating the hydroxygallium phthalocyanine Type I with a weak acid with a pKa greater than −1; and subsequently converting the hydroxygallium phthalocyanine Type I product obtained to Type V hydroxygallium phthalocyanine; and a process for the preparation of Type V hydroxygallium phthalocyanine which comprises the formation of an alkoxy-bridged gallium phthalocyanine dimer by the reaction of a gallium alkoxide, which has been formed from reacting gallium trichloride in a solvent, with a sodium alkoxide, and selecting the resulting mixture of gallium alkoxide and sodium chloride byproduct for the reaction with ortho-phthalodinitrile, or 1,3-diiminoisoindoline and a diol; hydrolyzing the resulting alkoxy-bridged gallium phthalocyanine dimer to hydroxygallium phthalocyanine; treating the hydroxygallium phthalocyanine Type I with a weak acid with a pKa greater than −1; and subsequently converting the product obtained to Type V hydroxygallium phthalocyanine by a solvent treatment.

Aspects of the present disclosure relate to a process which comprises treating a hydroxygallium phthalocyanine Type I with a weak acid having a pKa of at least equal to or greater than about −3, and subsequently converting the weak acid treated Type I to hydroxygallium phthalocyanine Type V as illustrated herein; a process wherein the weak acid pKa is from about −3 to about 15, and wherein the weak acid captures the metallic impurities present in the hydroxygallium phthalocyanine Type I; a process where the weak acid pKa is from about −1 to about 10, and wherein the hydroxygallium phthalocyanine obtained is Type V hydroxygallium phthalocyanine; a process wherein the weak acid pKa is from about 0 to about 6; a process where the weak acid is selected from the group consisting of acetic acid, trifluoroacetic acid, sulfurous acid, phosphoric acid, hydrofluoric acid, monofluoroacetic acid, monochloroacetic acid, monobromoacetic acid, monoiodoacetic acid, dichloroacetic acid, trichloroacetic acid, formic acid, oxalic acid, oxalacetic acid, acetylsalicylic acid, nicotinic acid, pyruvic acid, propionic acid, and mixtures thereof; a process wherein the acid is in the form of an acidic aqueous solution containing from about 1 weight percent to about 50 weight percent of the acid; a hydroxygallium phthalocyanine process where the weak acid is comprised of an acidic aqueous solution containing from about 2 weight percent to about 20 weight percent of the acid; a process wherein the ratio of the hydroxygallium phthalocyanine Type I to the weak acid is from about 90/10 to about 30/70, or is from about 80/20 to about 40/60; a process wherein the ratio of the hydroxygallium phthalocyanine Type I to the acid is from about 70/30 to about 50/50 phthalocyanine, and wherein there is removed from the hydroxygallium phthalocyanine Type I metallic impurities prior to its conversion to the hydroxygallium phthalocyanine Type V; a process wherein the hydroxygallium phthalocyanine Type I is subjected to filtration, isolation, and drying, and wherein there is removed from the hydroxygallium phthalocyanine Type I metallic impurities prior to its conversion to hydroxygallium phthalocyanine Type V; a process wherein there results hydroxygallium phthalocyanine with an X-ray diffraction pattern having characteristic major peaks at Bragg angles of 7.4, 9.8, 12.4, 12.9, 16.2, 18.4, 21.9, 23.9, 25.0, 28.1, and the highest peak at 7.4 degrees 2Θ (2Θ±0.2°); and a photoconductor comprised of a supporting substrate, a photogenerating layer, and a charge transport layer, and wherein the photogenerating layer contains hydroxygallium phthalocyanine Type V, which Type V is prepared as illustrated herein with the use of a weak acid with a pKa of greater than −3.

While not being desired to be limited by theory, it is believed that the weak acid dissolves metal impurities, such as gallium chloride, gallium oxide form soluble salts thereof, and which salts can be subsequently removed during the washing, and where the hydroxygallium phthalocyanine is substantially free of dissolution in the weak acid. In this manner, there can be formed layered photoconductors that when incorporated into printing machines result in final prints with minimal CDS.

Weak acids include those acids weaker than, for example, sulfuric acid, that is where the weak acids have a pKa of not less than −3, and more specifically with a pKa of from about −1 to about 10, or from about 1 to about 6. Specific examples of weak acids are acetic acid with a pKa of 4.76, trifluoroacetic acid with a pKa of −0.25, sulfurous acid with a pKa of 1.9 and 7.21, phosphoric acid with a pKa of 2.12, 7.21 and 12.67, hydrofluoric acid with a pKa of 3.17, monohaloacetic acid with a pKa of 2.66 (monofluoroacetic acid), 2.86 (monochloroacetic acid and monobromoacetic acid), and 3.12 (monoiodoacetic acid), dichloroacetic acid with a pKa of 1.29, trichloroacetic acid with a pKa of 0.65, and formic acid with a pKa of 3.77.

The following Examples are being submitted to illustrate embodiments of the present disclosure. These Examples are intended to be illustrative only and are not intended to limit the scope of the present disclosure. Also, parts and percentages are by weight unless otherwise indicated.

### SYNTHESIS COMPARATIVE EXAMPLE 1

### Synthesis of Type I Chlorogallium Phthalocyanine:

A 250 milliliter three-necked flask fitted with mechanical stirrer, condenser, and thermometer maintained under an atmosphere of argon was charged with 1,3-diiminoisoindolene (16 grams, 0.11 mole), gallium chloride (5 grams, 0.0284 mole; available from Aldrich Chemical), and 50 milliliters of N-methyl pyrrolidone (available from Aldrich Chemical). The resulting mixture was heated and stirred at reflux (202° C.) for 2 hours. The product was cooled to about 150° C., and filtered through a 150 milliliter M-porosity sintered glass funnel, which was preheated to approximately 150° C. with boiling N,N-dimethylformamide (DMF), and then washed thoroughly with three portions of 75 milliliters of boiling DMF, followed by three portions of 75 milliliters of DMF at room temperature, and then three portions of 50 milliliters of methanol, thus providing 7 grams (41 percent yield) of shiny purple crystals, identified by X-ray diffraction as being Type I chlorogallium phthalocyanine.

### Synthesis of Type I Hydroxygallium Phthalocyanine:

Hydrolysis of the above-obtained Type I chlorogallium phthalocyanine precursor was accomplished as follows. Sulfuric acid (125 grams) was heated to 40° C. in a 125 milliliter Erlenmeyer flask. To the heated acid was added 5 grams of the purple crystal pigment precursor chlorogallium phthalocyanine Type I. Addition of the solid was completed over a period of approximately 15 minutes, during which time the temperature of the solution increased to about 47° C. to 48° C. The acid solution was then stirred for 2 hours at 40° C., at which time it was added in a dropwise fashion to a mixture comprised of concentrated (−33 percent) ammonia (265 milliliters), and deionized water (435 milliliters), which had been cooled to a temperature below 5° C. Addition of the dissolved pigment was completed over the course of approximately 30 minutes, during which time the temperature of the solution increased to about 10° C. The reprecipitated pigment was then removed from the cooling bath, and allowed to stir at room temperature for 1 hour. The resulting pigment was then filtered through a porcelain funnel fitted with a Whatman 934-AH grade glass fiber filter. The resulting blue pigment was redispersed in fresh deionized water by stirring at room temperature for 1 hour, and filtered as before. This process was repeated three times until the conductivity of the filtrate was less than 20 μS. The filter cake was oven dried overnight at 50° C. to provide 4.75 grams (95 percent) of a dark blue solid, identified by X-ray diffraction as being Type I hydroxygallium phthalocyanine.

### Synthesis of Type V Hydroxygallium Phthalocyanine:

The obtained Type I hydroxygallium phthalocyanine above was then converted to Type V hydroxygallium phthalocyanine as follows. The pigment product Type I hydroxygallium phthalocyanine (3 grams) was added to 45 milliliters of N,N-dimethylformamide (BDH Assured) in a 120 milliliter glass bottle containing 90 grams of glass beads (1 millimeter diameter). The bottle was sealed and placed on a ball mill for 5 days. The resulting solid was isolated by filtration through a porcelain funnel fitted with a Whatman GF/F grade glass fiber filter, and washed in the filter using five portions of n-butyl acetate (50 milliliters) (BDH Assured). The filter cake obtained was oven dried overnight, about 18 hours, at 50° C., to provide 2.8 grams (93 percent) of a dark blue solid, which was identified as Type V hydroxygallium phthalocyanine by XRPD with major peaks at 7.4, 9.8, 12.4, 16.2, 17.6, 18.4, 21.9, 23.9, 25.0, 28.1, and the highest peak at 7.4 degrees 2Θ (2Θ±0.2°).

### SYNTHESIS COMPARATIVE EXAMPLE 2

### Synthesis of Alkoxy-bridged Gallium Phthalocyanine:

To a 1 liter round bottomed flask were added 25 grams of GaCl₃, and 300 milliliters of toluene, and the mixture was stirred for 10 minutes to form a solution. Then, 98 milliliters of a 25 weight percent sodium methoxide solution (in methanol) were added while cooling the flask with an ice bath to keep the contents below 40° C. Subsequently, 250 milliliters of ethylene glycol and 72.8 grams of o-phthalodinitrile were added. The methanol and toluene were quickly distilled off over 30 minutes while heating from 70° C. to 135° C., and then the phthalocyanine synthesis was performed by heating at 195° C. for 2 hours. The alkoxy-bridged gallium phthalocyanine dimer was isolated by filtration at 120° C. The product was then washed with 400 milliliters of DMF at 100° C. for 1 hour and filtered. The product was then washed with 400 milliliters of deionized water at 80° C. for 1 hour and filtered. The product was then washed with 400 milliliters of methanol at 60° C. for 1 hour and filtered. The product was dried at 60° C. under vacuum for 18 hours. The alkoxy-bridged gallium phthalocyanine dimer, 1,2-di(oxogallium phthalocyaninyl) ethane, was isolated as a dark blue solid in 80 percent yield. The dimer product was characterized by elemental analysis, infrared spectroscopy, and X-ray powder diffraction. Elemental analysis showed the presence of 0.05 percent chlorine. Infrared spectroscopy major peaks at 573, 611, 636, 731, 756, 775, 874, 897, 962, 999, 1069, 1088, 1125, 1165, 1289, 1337, 1424, 1466, 1503, 1611, 2569, 2607, 2648, 2864, 2950, and 3045 cm⁻¹; X-ray powder diffraction pattern peaks at Bragg angles of 6.7, 8.9, 12.8, 13.9, 15.7, 16.6, 21.2, 25.3, 25.9, and 28.3, with the highest peak at 6.7 degrees 20 (2Θ±0.2°).

### Synthesis of Type I Hydroxygallium Phthalocyanine:

The alkoxy-bridged gallium phthalocyanine dimer prepared as above was hydrolyzed as follows. Sulfuric acid (94 to 96 percent, 125 grams) was heated to 40° C. in a 125 milliliter Erlenmeyer flask, and then 5 grams of the alkoxy-bridged gallium phthalocyanine dimer were added, while stirring, over approximately 15 minutes, during which time the temperature of the solution increased to about 48° C. The acid solution was then stirred for 2 hours at 40° C., after which it was added in a dropwise fashion to a mixture comprised of concentrated (about 30 percent) ammonium hydroxide (265 milliliters), and deionized water (435 milliliters), which had been cooled to a temperature below 5° C. Addition of the dissolved dimer pigment was completed in about 30 minutes, during which time the temperature of the solution increased to about 40° C. The reprecipitated pigment was then removed from the cooling bath and allowed to stir at room temperature for 1 hour. It was then filtered through a porcelain funnel fitted with a Whatman 934-AH grade glass fiber filter. The resulting blue pigment was redispersed in fresh deionized water by stirring at room temperature for 1 hour and filtered as before. This process was repeated at least three times until the conductivity of the filtrate was <20 μS. The filtered cake was oven dried overnight at 50° C. to provide 4.4 grams (88 percent) of Type I hydroxygallium phthalocyanine, identified by infrared spectroscopy and X-ray powder diffraction. Infrared spectroscopy major peaks at 507, 573, 629, 729, 756, 772, 874, 898, 956, 984, 1092, 1121, 1165, 1188, 1290, 1339, 1424, 1468, 1503, 1588, 1611, 1757, 1835, 1951, 2099, 2207, 2280, 2384, 2425, 2570, 2608, 2652, 2780, 2819, 2853, 2907, 2951, 3049 and 3479 (very broad) cm⁻¹; X-ray diffraction pattern peaks at Bragg angles of 6.8, 13.0, 16.5, 21.0, 26.3 and 29.5, with the highest peak at 6.8 degrees 2Θ (2Θ±0.2°).

### Synthesis of Type V Hydroxygallium Phthalocyanine:

The Type I hydroxygallium phthalocyanine pigment obtained as above was converted to Type V hydroxygallium phthalocyanine as follows. The pigment (3 grams) was added to 45 milliliters of N,N-dimethylformamide in a 120 milliliter glass bottle containing 90 grams of glass beads (0.25 inch in diameter). The bottle was sealed and placed on a ball mill for 24 hours. The solid resulting was isolated by filtration through a porcelain funnel fitted with a Whatman GF/F grade glass fiber filter, and washed in the filter using several 50 milliliter portions of butyl acetate. The filtered cake was oven dried overnight at 50° C. to provide 2.8 grams of Type V hydroxygallium phthalocyanine, which was identified by infrared spectroscopy and X-ray powder diffraction. Infrared spectroscopy major peaks at 507, 571, 631, 733, 756, 773, 897, 965, 1067, 1084, 1121, 1146, 1165, 1291, 1337, 1425, 1468, 1503, 1588, 1609, 1757, 1848, 1925, 2099, 2205, 2276, 2384, 2425, 2572, 2613, 2653, 2780, 2861, 2909, 2956, 3057 and 3499 (broad) cm⁻¹; X-ray diffraction pattern peaks at Bragg angles of 7.4, 9.8,12.4,12.9,16.2, 18.4, 21.9, 23.9, 25.0 and 28.1, with the highest peak at 7.4 degrees 2Θ (2Θ±0.2°).

### SYNTHESIS EXAMPLE I

A Type V hydroxygallium phthalocyanine pigment was prepared by repeating the process of Synthesis Comparative Example 1 except that a weak acid treatment of the Type I hydroxygallium phthalocyanine was accomplished before the conversion process from Type I to Type V as follows. The pigment product Type I hydroxygallium phthalocyanine (20 grams) was mixed with a 400 milliliter mixture of water and glacial acetic acid with a pKa of 4.76 (20/1, v/v) for half an hour, and the mixture was subsequently hose vacuum filtered through a 600 milliliter Buchner funnel with a fibrous glass frit of from about 4 to about 8 μm in porosity. The pigment resulting was then well mixed with 800 milliliters of hot water (>90° C.), and vacuum filtered in the funnel. The resulting pigment was then mixed with 800 milliliters of cold water, and vacuum filtered in the funnel. The final water filtrate was measured for conductivity, which was below about 10 μS. The resulting wet cake was then thoroughly mixed with 800 milliliters of methanol, and vacuum filtered in the funnel. The wet cake was dried at 65° C. under vacuum, and the product obtained was identified as Type I hydroxygallium phthalocyanine on the basis of its X-ray powder diffraction trace.

### SYNTHESIS EXAMPLE II

A Type V hydroxygallium phthalocyanine pigment was prepared by repeating the process of Synthesis Comparative Example 2 except that there was further accomplished the weak acid treatment of the Type I hydroxygallium phthalocyanine, and wherein this acid was added prior to the conversion process from Type I to Type V as follows.

The pigment product Type I hydroxygallium phthalocyanine (10 grams) was mixed with a 400 milliliter mixture of water, and the weak acid glacial acetic acid with a pKa of 4.76 (20/1, v/v) for half an hour, and the mixture was subsequently hose vacuum filtered through a 600 milliliter Buchner funnel with a fibrous glass frit of from about 4 to about 8 μm in porosity. The pigment resulting was then well mixed with 800 milliliters of hot water (>90° C.), and vacuum filtered in the funnel. The resulting pigment was then mixed with 800 milliliters of cold water, and vacuum filtered in the funnel. The final water filtrate was measured for conductivity, which was below about 10 μS. The resulting wet cake was then thoroughly mixed with 800 milliliters of methanol, and vacuum filtered in the funnel. The wet cake was dried at 65° C. under vacuum, and the product obtained was identified as Type I hydroxygallium phthalocyanine on the basis of its X-ray powder diffraction trace.

### COMPARATIVE EXAMPLE 1

A photoconductor was prepared by providing a 0.02 micrometer thick titanium layer coated on a biaxially oriented polyethylene naphthalate substrate (KALEDEX™ 2000) having a thickness of 3.5 mils, and applying thereon, with a gravure applicator or an extrusion coater, a solution containing 50 grams of 3-amino-propyltriethoxysilane, 41.2 grams of water, 15 grams of acetic acid, 684.8 grams of denatured alcohol, and 200 grams of heptane. This layer was then dried for about 5 minutes at 135° C. in the forced air dryer of the coater. The resulting blocking layer had a dry thickness of 500 Angstroms. An adhesive layer was then prepared by applying a wet coating over the blocking layer, using a gravure applicator or an extrusion coater, and which adhesive contains 0.2 percent by weight based on the total weight of the solution of the copolyester adhesive (ARDEL™ D100 available from Toyota Hsutsu Inc.) in a 60:30:10 volume ratio mixture of tetrahydrofuran/monochlorobenzene/methylene chloride. The adhesive layer was then dried for about 5 minutes at 135° C. in the forced air dryer of the coater. The resulting adhesive layer had a dry thickness of 200 Angstroms.

A photogenerating layer dispersion was prepared by introducing 0.45 gram of the known polycarbonate IUPILON 200™ (PCZ-200) or Polycarbonate Z, weight average molecular weight of 20,000, available from Mitsubishi Gas Chemical Corporation, and 50 milliliters of tetrahydrofuran (THF) into a 4 ounce glass bottle. To this solution were added 2.4 grams of hydroxygallium phthalocyanine Type V as prepared above in Synthesis Comparative Example 1, wherein the hydroxygallium phthalocyanine precursor was chlorogallium phthalocyanine, and 300 grams of 1/8 inch (3.2 millimeter) diameter stainless steel shot. This mixture was then placed on a ball mill for 8 hours. Subsequently, 2.25 grams of PCZ-200 was dissolved in 46.1 grams of THF, and added to the hydroxygallium phthalocyanine dispersion. This slurry was then placed on a shaker for 10 minutes. The resulting dispersion was, thereafter, applied to the above adhesive interface with a Bird applicator to form a photogenerating layer having a wet thickness of 0.50 mil. A strip about 10 millimeters wide along one edge of the substrate web bearing the blocking layer and the adhesive layer was deliberately left uncoated by any of the photogenerating layer material to facilitate adequate electrical contact by the ground strip layer that was applied later. The photogenerating layer was dried at 120° C. for 1 minute in a forced air oven to form a dry photogenerating layer having a thickness of 0.8 micron.

The imaging member or photoconductor web was then overcoated with a two-layer charge transport layer. Specifically, the photogenerating layer was overcoated with a charge transport layer (the bottom layer) in contact with the photogenerating layer. The bottom layer of the charge transport layer was prepared by introducing into an amber glass bottle in a weight ratio of 1:1 N,N′-diphenyl-N,N′-bis(3-methylphenyl)-1,1′-biphenyl-4,4′-diamine and MAKROLON® 5705, a known polycarbonate resin having a molecular weight average of from about 50,000 to about 100,000, commercially available from Farbenfabriken Bayer A.G. The resulting mixture was then dissolved in methylene chloride to form a solution containing 15 percent by weight solids. This solution was applied on the photogenerating layer to form a coating of the bottom layer that upon drying (120° C. for 1 minute) had a thickness of 14.5 microns. During this coating process, the humidity was equal to or less than 15 percent.

The bottom layer of the charge transport layer was overcoated with a top layer. The charge transport layer solution of the top layer was prepared as described above for the bottom layer. This solution was applied on the bottom layer of the charge transport layer to form a coating that upon drying (120° C. for 1 minute) had a thickness of 14.5 microns. During this coating process, the humidity was equal to or less than 15 percent.

### COMPARATIVE EXAMPLE 2

A photoconductor was prepared by repeating the process of Comparative Example 1 except that the Type V hydroxygallium phthalocyanine used was prepared an illustrated in above Synthesis Comparative Example 2 wherein the hydroxygallium phthalocyanine precursor was an alkoxy-bridged gallium phthalocyanine.

### EXAMPLE I

A photoconductor was prepared by repeating the process of Comparative Example 1 except that the Type V hydroxygallium phthalocyanine used was prepared an illustrated in the above Synthesis Example 1 wherein the hydroxygallium phthalocyanine precursor was chlorogallium phthalocyanine, and the Type I hydroxygallium phthalocyanine was treated with an acetic acid solution.

### EXAMPLE II

A photoconductor was prepared by repeating the process of Comparative Example 1 except that the Type V hydroxygallium phthalocyanine used was prepared an illustrated in the above Synthesis Example 2 wherein the hydroxygallium phthalocyanine precursor was an alkoxy-bridged gallium phthalocyanine, and the Type I hydroxygallium phthalocyanine was treated with an acetic acid solution.

### Electrical Property Testing

The above prepared photoconductor devices were tested in a scanner set to obtain photoinduced discharge cycles, sequenced at one charge-erase cycle, followed by one charge-expose-erase cycle wherein the light intensity was incrementally increased with cycling to produce a series of photoinduced discharge characteristic curves from which the photosensitivity and surface potentials at various exposure intensities were measured. Additional electrical characteristics were obtained by a series of charge-erase cycles with incrementing surface potential to generate several voltage versus charge density curves. The scanner was equipped with a scorotron set to a constant voltage charging at various surface potentials. The devices were tested at surface potentials of 500 volts with the exposure light intensity incrementally increased by means of regulating a series of neutral density filters; the exposure light source is a 780 nanometer light emitting diode. The xerographic simulation was completed in an environmentally controlled light tight chamber at ambient conditions (40 percent relative humidity and 22° C.).

There was no difference in PIDC between these four devices. Treatment of the hydroxygallium phthalocyanine Type I with a weak acid as well as the hydroxygallium phthalocyanine Type I source (from chlorogallium phthalocyanine or alkoxy-bridged gallium phthalocyanine) did not change the electrical responses of the photoconductor device.

### Charge Deficient Spots (CDS) Measurements

Various known methods have been developed to assess and/or accommodate the occurrence of charge deficient spots. For example, U.S. Pat. Nos. 5,703,487 and 6,008,653, the disclosures of each patent being totally incorporated herein by reference, disclose processes for ascertaining the microdefect levels of an electrophotographic imaging member or photoconductor. The method of U.S. Pat. No. 5,703,487, the disclosure of which is totally incorporated herein by reference, designated as field-induced dark decay (FIDD), involves measuring either the differential increase in charge over and above the capacitive value, or measuring reduction in voltage below the capacitive value of a known imaging member and of a virgin imaging member, and comparing differential increase in charge over and above the capacitive value or the reduction in voltage below the capacitive value of the known imaging member and of the virgin imaging member.

U.S. Pat. Nos. 6,008,653 and 6,150,824, the disclosures of each patent being totally incorporated herein by reference, disclose a method for detecting surface potential charge patterns in an electrophotographic imaging member with a floating probe scanner. Floating Probe Micro Defect Scanner (FPS) is a contactless process for detecting surface potential charge patterns in an electrophotographic imaging member. The scanner includes a capacitive probe having an outer shield electrode, which maintains the probe adjacent to and spaced from the imaging surface to form a parallel plate capacitor with a gas between the probe and the imaging surface, a probe amplifier optically coupled to the probe, establishing relative movement between the probe and the imaging surface, a floating fixture which maintains a substantially constant distance between the probe and the imaging surface. A constant voltage charge is applied to the imaging surface prior to relative movement of the probe and the imaging surface past each other, and the probe is synchronously biased to within about ±300 volts of the average surface potential of the imaging surface to prevent breakdown, measuring variations in surface potential with the probe, compensating the surface potential variations for variations in distance between the probe and the imaging surface, and comparing the compensated voltage values to a baseline voltage value to detect charge patterns in the electrophotographic imaging member. This process may be conducted with a contactless scanning system comprising a high resolution capacitive probe, a low spatial resolution electrostatic voltmeter coupled to a bias voltage amplifier, and an imaging member having an imaging surface capacitively coupled to and spaced from the probe and the voltmeter. The probe comprises an inner electrode surrounded by and insulated from a coaxial outer Faraday shield electrode, the inner electrode connected to an opto-coupled amplifier, and the Faraday shield connected to the bias voltage amplifier. A threshold of 20 volts is commonly chosen to count charge deficient spots.

The above-prepared photoconductors were measured for CDS counts using the above-described FPS technique, and the results follow in Table 1.

TABLE 1

| | CDS (counts/cm²) |
|---|---|
| Comparative Example 1 | 11.2 |
| Example I | 4.2 |
| Comparative Example 2 | 9.7 |
| Example II | 4.5 |

The above data indicates that the CDS for the photoconductor of Example I where the Type I hydroxygallium phthalocyanine was treated with a weak acid prior to its conversion to hydroxygallium phthalocyanine Type V, and where the Type I hydroxygallium phthalocyanine was obtained from chlorogallium phthalocyanine exhibited lower CDS than the photoconductor of Comparative Example 1 where the Type I hydroxygallium phthalocyanine was not treated with a weak acid prior to the conversion. More specifically, the CDS of Examples I and II was about one third less as compared to the Comparative Example 1.

The above data additionally indicates that the CDS for the photoconductor of Example II where the Type I hydroxygallium phthalocyanine was treated with a weak acid prior to the conversion, and the Type I hydroxygallium phthalocyanine was obtained from alkoxy-bridged gallium phthalocyanine exhibited lower CDS than the photoconductor of Comparative Example 2 where the Type I hydroxygallium phthalocyanine was not treated with a weak acid prior to the conversion. More specifically, the CDS was about one half of the controlled Comparative Example 2.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A process which comprises treating a hydroxygallium phthalocyanine Type I with a weak acid having a pKa of at least equal to or greater than about −3, and subsequently contacting said hydroxygallium phthalocyanine Type I with an organic solvent.

2. A process in accordance with claim 1 wherein there is obtained hydroxygallium phthalocyanine Type V by first hydrolyzing a halogallium phthalocyanine or an alkoxy-bridged gallium phthalocyanine to said hydroxygallium phthalocyanine Type I.

3. A process in accordance with claim 2 wherein said halogallium phthalocyanine is obtained by the reaction of a gallium halide with a 1,3-diiminoisoindolene or ortho-phthalodinitrile in an organic solvent, and wherein there is obtained hydroxygallium phthalocyanine Type V.

4. A process in accordance with claim 1 wherein said hydroxygallium phthalocyanine Type V is obtained by the hydrolysis of halogallium phthalocyanine precursor to hydroxygallium phthalocyanine Type I, treatment of the resulting hydroxygallium phthalocyanine Type I with said weak acid, and conversion of the resulting weak acid treated hydroxygallium phthalocyanine Type I to Type V hydroxygallium phthalocyanine by contacting said hydroxygallium phthalocyanine Type I with an organic solvent of N,N-dimethylformamide, and wherein the precursor halogallium phthalocyanine is obtained by the reaction of a gallium halide with a 1,3-diiminoisoindolene or ortho-phthalodinitrile in an organic solvent.

5. A process in accordance with claim 2 wherein said alkoxy-bridged gallium phthalocyanine is obtained by the reaction of a gallium halide, a 1,3-diiminoisoindolene, ortho-phthalodinitrile, or a diol in an organic solvent, and wherein said diol is selected from the group consisting of ethylene glycol, 1,3-propanediol, 2-methyl-1,3-propanediol, 2,2-dimethyl-1,3-propanediol, 1,3-butanediol, 2,3-butanediol, 1,4-butanediol, 1,4-cyclohexanediol, 1,6-hexanediol, and the like, and mixtures thereof, and there is obtained hydroxygallium phthalocyanine Type V.

6. A process in accordance with claim 1 wherein said hydroxygallium phthalocyanine Type V is obtained by the hydrolysis of a alkoxy-bridged gallium phthalocyanine precursor to hydroxygallium phthalocyanine Type I, treatment of the resulting hydroxygallium phthalocyanine Type I with said weak acid, and conversion of the resulting weak acid treated hydroxygallium phthalocyanine Type I to Type V hydroxygallium phthalocyanine by contacting said hydroxygallium phthalocyanine Type I with an organic solvent of N,N-dimethylformamide, and wherein the precursor halogallium phthalocyanine is obtained by the reaction of a gallium halide, a 1,3-diiminoisoindolene or ortho-phthalodinitrile, and ethylene glycol in an organic solvent.

7. A process in accordance with claim 1 wherein said pKa is from about -1 to about 15, and wherein said weak acid captures the metallic impurities present in said hydroxygallium phthalocyanine Type I.

8. A process in accordance with claim 1 wherein said pKa is from about 0 to about 10, and wherein the hydroxygallium phthalocyanine obtained is Type V hydroxygallium phthalocyanine.

9. A process in accordance with claim 1 wherein said pKa is from about 1 to about 6, and wherein the hydroxygallium phthalocyanine obtained is Type V hydroxygallium phthalocyanine.

10. A process in accordance with claim 1 wherein said weak acid is selected from the group consisting of acetic acid, trifluoroacetic acid, sulfurous acid, phosphoric acid, hydrofluoric acid, monofluoroacetic acid, monochloroacetic acid, monobromoacetic acid, monoiodoacetic acid, dichloroacetic acid, trichloroacetic acid, formic acid, oxalic acid, acetylsalicylic acid, nicotinic acid, pyruvic acid, propionic acid, oxalacetic acid, trifluoroacetic acid, and mixtures thereof.

11. A process in accordance with claim 1 wherein said acid is an acidic aqueous solution containing from about 1 weight percent to about 50 weight percent of the acid.

12. A process in accordance with claim 1 wherein said acid is comprised of an acidic aqueous solution containing from about 2 weight percent to about 20 weight percent of the acid.

13. A process in accordance with claim 1 wherein the ratio of said hydroxygallium phthalocyanine Type I to said acid is from about 90/10 to about 30/70.

14. A process in accordance with claim 1 wherein the ratio of said hydroxygallium phthalocyanine Type I to said acid is from about 80/20 to about 40/60.

15. A process in accordance with claim 1 wherein the ratio of said hydroxygallium phthalocyanine Type I to said acid is from about 70/30 to about 50/50 wherein the hydroxygallium phthalocyanine obtained is Type V hydroxygallium phthalocyanine, and wherein there is removed from said hydroxygallium phthalocyanine Type I impurities prior to conversion to hydroxygallium phthalocyanine Type V product.

16. A process in accordance with claim 1 wherein said hydroxygallium phthalocyaine Type I is subjected to filtration, isolation, and drying, and wherein there is removed from said hydroxygallium phthalocyanine Type I metallic impurities prior to its conversion to hydroxygallium phthalocyanine Type V.

17. A process in accordance with claim 1 wherein there results hydroxygallium phthalocyanine Type V with an X-ray diffraction pattern having characteristic diffraction peaks at Bragg angles of 7.4, 9.8, 12.4, 12.9, 16.2, 18.4, 21.9, 23.9, 25.0 and 28.1, with the highest peak at 7.4 degrees 20 (2Θ±0.2°).

18. A process in accordance with claim 1 which comprises mixing a hydroxygallium phthalocyanine Type I with an acid with a pKa of from about −1 to about 12, and converting said resulting acid treated Type I to hydroxygallium phthalocyanine Type V, and which conversion is accomplished by treating or contacting hydroxygallium phthalocyanine Type I with an organic solvent selected from a group consisting of N,N-dimethylformamide, N-methyl pyrrolidinone, dimethylsulfoxide, pyridine, acetone, methyl ethyl ketone, methyl isobutyl ketone, and the like, and mixtures thereof.

19. A process in accordance with claim 18 wherein there is removed from said hydroxygallium phthalocyanine Type I metallic impurities prior to its conversion to hydroxygallium phthalocyanine Type V.

20. A photoconductor comprised of a supporting substrate, a photogenerating layer and a charge transport layer, and wherein said photogenerating layer contains hydroxygallium phthalocyanine Type V, which Type V is prepared by treating hydroxygallium phthalocyanine Type I with a weak acid with a pKa of greater than about −3, and subsequently contacting said hydroxygallium phthalocyanine Type I mixture with an organic solvent to obtain said hydroxygallium phthalocyanine Type V.

21. A photoconductor in accordance with claim 20 wherein said pKa is from about −1 to about 15, and wherein said organic solvent is selected from a group consisting of N,N-dimethylformamide, N-methyl pyrrolidinone, dimethylsulfoxide, pyridine, acetone, methyl ethyl ketone, methyl isobutyl ketone, and mixtures thereof.

22. A photoconductor in accordance with claim 20 wherein said pka is from about 1 to about 10.

23. A photoconductor in accordance with claim 20 wherein said pka is from about 2 to about 6.

24. A photoconductor in accordance with claim 20 wherein said charge transport layer contains an aryl amine selected from the group consisting of at least one of N,N′-diphenyl-N,N-bis(3-methylphenyl)-1,1′-biphenyl-4,4′-diamine, N,N′-diphenyl-N,N-bis(4-methylphenyl)-1,1 ′-biphenyl-4,4′-diamine, N,N′-diphenyl-N,N-bis(2-methylphenyl)-1,1′-biphenyl-4,4′-diamine, and N,N,N′N′-tetra(4-methylphenyl)-(1,1′-biphenyl)-4,4′-diamine.

25. A photoconductor in accordance with claim 20 further including a hole blocking layer, and an adhesive layer.

26. A photoconductor in accordance with claim 20 wherein said charge transport layer comprises at least one of 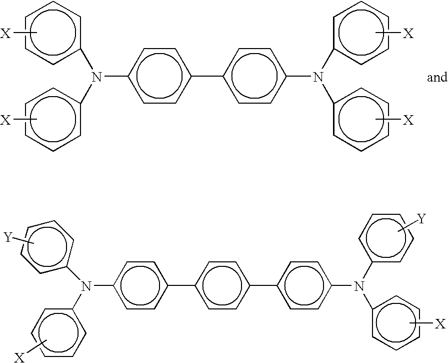
wherein each X is independently alkyl, alkoxy, aryl, a halogen, and mixtures thereof; and wherein X and Y are independently alkyl, alkoxy, aryl, a halogen, and mixtures thereof.

27. A photoconductor in accordance with claim 20 wherein said hydroxygallium phthalocyanine Type V possesses diffraction peaks at Bragg angles of 7.4, 9.8, 12.4, 12.9, 16.2, 18.4, 21.9, 23.9, 25.0 and 28.1, with the highest peak at 7.4 degrees 2Θ (2Θ±0.2°).

28. A photoconductor in accordance with claim 20 wherein said acid is selected from the group consisting of acetic acid, trifluoroacetic acid, sulfurous acid, phosphoric acid, hydrofluoric acid, monofluoroacetic acid, monochloroacetic acid, monobromoacetic acid, monoiodoacetic acid, dichloroacetic acid, trichloroacetic acid, formic acid, oxalic acid, acetylsalicylic acid, nicotinic acid, pyruvic acid, propionic acid, oxalacetic acid, and mixtures thereof.

29. A photoconductor in accordance with claim 20 wherein said acid is acetic acid.

30. A process in accordance with claim 1 wherein said acid is acetic acid.

31. A process in accordance with claim 1 wherein said acid is acetic acid pKa of about 4.76; trifluoroacetic acid pKa of about 0.3; or phosphoric acid pKa of about 2.12, 7.21 or 12.67.

32. A photoconductor comprised of a supporting substrate, a photogenerating layer comprised of a photogenerating pigment of hydroxygallium phthalocyanine Type V, and wherein said Type V is prepared by treating a hydroxygallium phthalocyanine Type I with a weak acid having a pKa of at least equal to or greater than about −3, and subsequently contacting said hydroxygallium phthalocyanine Type I with an organic solvent; and wherein said hydroxygallium phthalocyanine Type V is obtained by the hydrolysis of halogallium phthalocyanine precursor to hydroxygallium phthalocyanine Type I, treatment of the resulting hydroxygallium phthalocyanine Type I with said weak acid, and conversion of the resulting weak acid treated hydroxygallium phthalocyanine Type I to Type V hydroxygallium phthalocyanine by contacting said hydroxygallium phthalocyanine Type I with an organic solvent of N,N-dimethylformamide, and wherein the precursor halogallium phthalocyanine is obtained by the reaction of a gallium halide with a 1,3-diiminoisoindolene or ortho-phthalodinitrile in an organic solvent.
